(19) United States
(12) Patent Application Publication
(10) Pub. No.: US 2025/0159702 A1
(43) Pub. Date: May 15, 2025

(54) TECHNIQUES FOR HANDLING GROUPCAST FEEDBACK COMMUNICATION

(71) Applicant: QUALCOMM Incorporated, San Diego, CA (US)

(72) Inventors: Ramprasad MAJJARI, Nellore (IN); Bapineedu Chowdary GUMMADI, Hyderabad (IN)

(21) Appl. No.: 18/505,953

(22) Filed: Nov. 9, 2023

(51) Int. Cl. H04W 72/30; H04L 1/1829

(52) U.S. Cl. CPC H04W 72/30; H04L 1/1829

(57) ABSTRACT

Methods, systems, and devices for wireless communications are described. Techniques described herein provide for a technique for a transmitting user equipment (TX UE) to handle groupcast feedback communication by starting the groupcast communication using a mode one groupcast feedback and by changing to a mode two groupcast feedback based on a metric of retransmissions exceeding a threshold. For example, the TX UE may transmit control signaling indicating mode one groupcast feedback. The TX UE may transmit a plurality of groupcast messages and may receive one or more NACK feedback messages associated with the plurality of groupcast messages. The TX UE may performs one or more retransmissions of groupcast messages based on the received NACK feedback messages. If a metric of the one or more retransmissions exceeds a threshold quantity, the TX UE may transmit second control signaling indicating the mode two groupcast feedback.

### FIELD OF TECHNOLOGY

The following relates to wireless communications, including techniques for handling groupcast feedback communication.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support techniques for handling groupcast feedback communication. For example, the described techniques provide for a transmitting user equipment (TX UE) to handle groupcast feedback communication by starting the groupcast communication using mode one groupcast feedback and by changing to mode two groupcast feedback based on a metric of the retransmissions exceeding a threshold. For example, the TX UE may transmit control signaling indicating mode one groupcast feedback. The TX UE may transmit a plurality of groupcast messages and may receive one or more NACK feedback messages associated with the plurality of groupcast messages. The TX UE may perform one or more retransmissions of groupcast messages based on the received NACK feedback messages. If a metric of the one or more retransmissions exceeds a threshold quantity, the TX UE may transmit second control signaling indicating the mode two groupcast feedback. The metric of the one or more retransmissions may include a block error rate of the one or more retransmissions or a quantity of the one or more retransmissions.

A method for wireless communication by a first UE is described. The method may include transmitting first control signaling indicating a first mode of groupcast feedback, where the first mode is associated with transmission of NACK feedback and suppression of ACK feedback, transmitting a set of multiple groupcast messages, each of the set of multiple groupcast messages including a respective transport block, receiving one or more NACK feedback messages associated with one or more of the set of multiple groupcast messages according to the first mode, where each of the one or more NACK feedback messages indicates that reception of at least a portion of the respective transport block was unsuccessful, performing one or more retransmissions of the one or more of the set of multiple groupcast messages based on the one or more NACK feedback messages, and transmitting second control signaling indicating a second mode of groupcast feedback based on a metric of the one or more retransmissions exceeding a first threshold, where the second mode is associated with monitoring for NACK feedback and ACK feedback.

A first UE for wireless communication is described. The first UE may include one or more memories storing processor executable code, and one or more processors coupled with the one or more memories. The one or more processors may individually or collectively operable to execute the code to cause the first UE to transmit first control signaling indicating a first mode of groupcast feedback, where the first mode is associated with transmission of NACK feedback and suppression of ACK feedback, transmit a set of multiple groupcast messages, each of the set of multiple groupcast messages including a respective transport block, receive one or more NACK feedback messages associated with one or more of the set of multiple groupcast messages according to the first mode, where each of the one or more NACK feedback messages indicates that reception of at least a portion of the respective transport block was unsuccessful, perform one or more retransmissions of the one or more of the set of multiple groupcast messages based on the one or more NACK feedback messages, and transmit second control signaling indicating a second mode of groupcast feedback based on a metric of the one or more retransmissions exceeding a first threshold, where the second mode is associated with monitoring for NACK feedback and ACK feedback.

Another first UE for wireless communication is described. The first UE may include means for transmitting first control signaling indicating a first mode of groupcast feedback, where the first mode is associated with transmission of NACK feedback and suppression of ACK feedback, means for transmitting a set of multiple groupcast messages, each of the set of multiple groupcast messages including a respective transport block, means for receiving one or more NACK feedback messages associated with one or more of the set of multiple groupcast messages according to the first mode, where each of the one or more NACK feedback messages indicates that reception of at least a portion of the respective transport block was unsuccessful, means for performing one or more retransmissions of the one or more of the set of multiple groupcast messages based on the one or more NACK feedback messages, and means for transmitting second control signaling indicating a second mode of groupcast feedback based on a metric of the one or more retransmissions exceeding a first threshold, where the second mode is associated with monitoring for NACK feedback and ACK feedback.

A non-transitory computer-readable medium storing code for wireless communication is described. The code may include instructions executable by a processor to transmit first control signaling indicating a first mode of groupcast feedback, where the first mode is associated with transmission of NACK feedback and suppression of ACK feedback, transmit a set of multiple groupcast messages, each of the set of multiple groupcast messages including a respective transport block, receive one or more NACK feedback messages associated with one or more of the set of multiple groupcast messages according to the first mode, where each of the one or more NACK feedback messages indicates that reception of at least a portion of the respective transport block was unsuccessful, perform one or more retransmissions of the one or more of the set of multiple groupcast messages based on the one or more NACK feedback messages, and transmit second control signaling indicating a second mode of groupcast feedback based on a metric of the one or more retransmissions exceeding a first threshold, where the second mode is associated with monitoring for NACK feedback and ACK feedback.

In some examples of the method, first UE, and non-transitory computer-readable medium described herein, transmitting the second control signaling may include operations, features, means, or instructions for transmitting the second control signaling based on the block error rate exceeding the first threshold.

In some examples of the method, first UE, and non-transitory computer-readable medium described herein, the metric of the one or more retransmissions includes a quantity of the one or more NACK feedback messages.

Some examples of the method, first UE, and non-transitory computer-readable medium described herein may further include operations, features, means, or instructions for transmitting a second set of multiple groupcast messages, receiving, from a second UE, one or more second NACK feedback messages associated with one or more of the second set of multiple groupcast messages according to the second mode, and transmitting third control signaling indicating the first mode of groupcast feedback.

Some examples of the method, first UE, and non-transitory computer-readable medium described herein may further include operations, features, means, or instructions for transmitting a third set of multiple groupcast messages, receiving one or more third NACK feedback messages associated with one or more of the third set of multiple groupcast messages according to the first mode, and suppressing one or more retransmissions of the one or more of the third set of multiple groupcast messages based on the one or more third NACK feedback messages.

Some examples of the method, first UE, and non-transitory computer-readable medium described herein may further include operations, features, means, or instructions for transmitting a third set of multiple groupcast messages, receiving one or more third NACK feedback messages associated with one or more of the third set of multiple groupcast messages according to the first mode, and performing a fixed quantity of retransmissions of the one or more of the third set of multiple groupcast messages based on the one or more third NACK feedback messages.

Some examples of the method, first UE, and non-transitory computer-readable medium described herein may further include operations, features, means, or instructions for transmitting, to a third UE, to a network entity, to a vehicle-to-everything application server or any combination thereof, signaling indicating a removal of the second UE from groupcast communication.

Some examples of the method, first user UE, and non-transitory computer-readable medium described herein may further include operations, features, means, or instructions for transmitting, to a third UE, to a network entity, to a vehicle-to-everything application server or any combination thereof, signaling indicating the second UE may have violated a limit associated with NACK feedback messages.

### BRIEF DESCRIPTION OF THE DRAWINGS

FIG. 1 shows an example of a wireless communications system that supports techniques for handling groupcast feedback communication in accordance with one or more aspects of the present disclosure.

FIG. 2 shows an example of a wireless communications system that supports techniques for handling groupcast feedback communication in accordance with one or more aspects of the present disclosure.

FIG. 3 shows an example of a wireless communications system that supports techniques for handling groupcast feedback communication in accordance with one or more aspects of the present disclosure.

FIG. 4 shows an example of a process flow that supports techniques for handling groupcast feedback communication in accordance with one or more aspects of the present disclosure.

FIGS. 5 and 6 show block diagrams of devices that support techniques for handling groupcast feedback communication in accordance with one or more aspects of the present disclosure.

FIG. 7 shows a block diagram of a communications manager that supports techniques for handling groupcast feedback communication in accordance with one or more aspects of the present disclosure.

FIG. 8 shows a diagram of a system including a device that supports techniques for handling groupcast feedback communication in accordance with one or more aspects of the present disclosure.

FIGS. 9 through 10 show flowcharts illustrating methods that support techniques for handling groupcast feedback communication in accordance with one or more aspects of the present disclosure.

### DETAILED DESCRIPTION

In groupcast sidelink communication, a transmitting (TX) user equipment (UE) may transmit a groupcast message comprising a transport block to one or more receiving (RX) UEs. In some cases, groupcast communication has two options for sidelink hybrid automatic repeat request (HARQ) feedback, which may be referred to as mode one and mode two. In mode one (e.g., or option one) groupcast feedback, the RX UE may transmit a negative acknowledgment (NACK) feedback message if the transport block was not successfully decoded and may suppress (e.g., not transmit) an acknowledgment (ACK) feedback message if the transport block was successfully decoded. In mode two (e.g., or option two) groupcast feedback, the RX UE may transmit an ACK feedback message if the transport block was successfully decoded and may transmit the NACK feedback message if the transport block was not successfully decoded.

In mode one groupcast feedback, the TX UE may be unable to identify which UE is sending NACK feedback messages. If, in mode one groupcast feedback, the TX UE receives at least one NACK feedback message corresponding to the transmitted groupcast message, the TX UE may retransmit the groupcast message. In mode one groupcast feedback, if one of the RX UEs repeatedly sends the NACK feedback message for the groupcast message, the TX UE may continue to retransmit the groupcast message consuming resources. In some cases, the RX UE may have an equipment fault causing the NACK feedback messages or a rogue UE may be purposefully sending the NACK feedback messages to block resources.

To address the potential repeating NACK feedback messages and associated repeating retransmissions, the TX UE may handle groupcast feedback communication by starting the groupcast communication using mode one groupcast feedback and by changing to mode two groupcast feedback based on a metric of the retransmissions exceeding a threshold. For example, the TX UE may transmit control signaling indicating mode one groupcast feedback. The TX UE may transmit a plurality of groupcast messages and may receive one or more NACK feedback messages associated with the plurality of groupcast messages. The TX UE may perform one or more retransmissions of groupcast messages based on the received NACK feedback messages. If a metric of the one or more retransmissions exceeds a threshold quantity, the TX UE may transmit second control signaling indicating the mode two groupcast feedback. The metric of the one or more retransmissions may include a block error rate of the one or more retransmissions or a quantity of the one or more retransmissions of the groupcast message based on the received NACK feedback.

The TX UE may transmit a second plurality of groupcast messages and may receive one or more mode two feedback messages (e.g., NACK feedback messages or ACK feedback messages associated with one or more of the second plurality of groupcast messages). Using the mode two groupcast feedback messages, the TX UE may identify one of the RX UEs sending repeating NACK feedback messages. After identifying the RX UE sending the repeating NACK feedback messages, the TX UE may transmit control signaling indicating mode one groupcast feedback. While operating in the mode one groupcast feedback, the TX UE may ignore the NACK feedback messages, may suppress the retransmissions associated with the NACK feedback messages, or may remove the identified RX UE from groupcast communication. Additionally, the TX UE may transmit a message indicating a presence of a rogue UE or faulty UE to other UEs, to a network entity, or to a vehicle-to-everything (V2X) server.

Aspects of the disclosure are initially described in the context of wireless communications systems. Aspects of the disclosure are also described in context of a process flow. Aspects of the disclosure are further illustrated by and described with reference to apparatus diagrams, system diagrams, and flowcharts that relate to techniques for handling groupcast feedback communication.

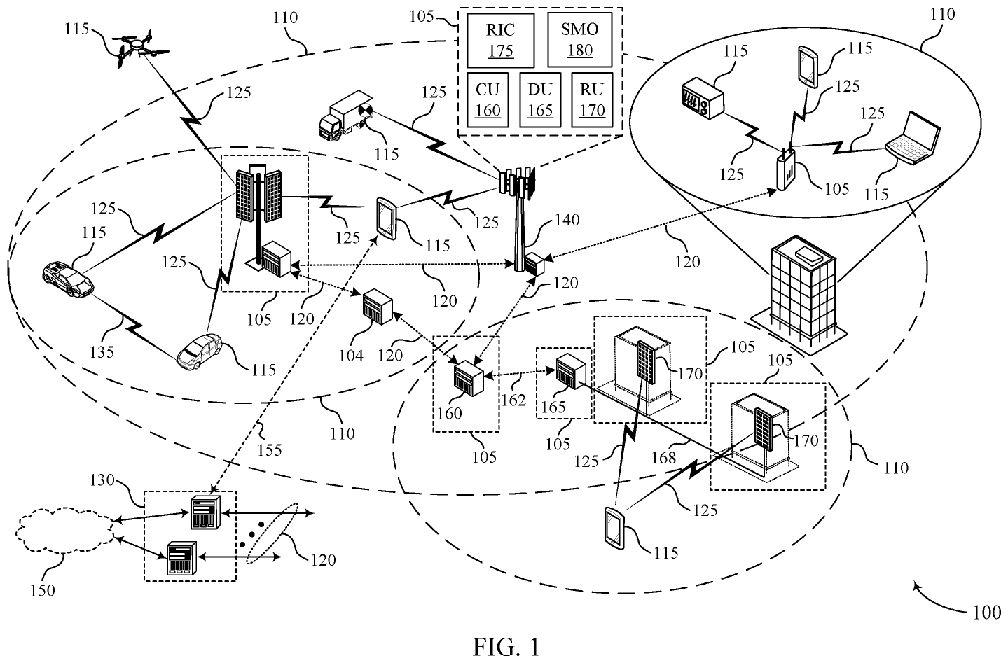

FIG. 1 shows an example of a wireless communications system 100 that supports techniques for handling groupcast feedback communication in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support techniques for handling groupcast feedback communication as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In groupcast sidelink communication, a TX UE 115 may transmit a groupcast message comprising a transport block to one or more RX UEs 115. Groupcast communication has two options for sidelink HARQ feedback. In mode one (e.g., or option one) groupcast feedback, the RX UE 115 may transmit a NACK feedback message if the transport block was not successfully decoded and may suppress (e.g., not transmit) an ACK feedback message if the transport block was successfully decoded. In mode two (e.g., or option two) groupcast feedback, the RX UE 115 may transmit an ACK feedback message if the transport block was successfully decoded and may transmit the NACK feedback message if the transport block was not successfully decoded.

In mode one groupcast feedback, if the TX UE 115 receives at least one NACK feedback message corresponding to the transmitted groupcast message, the TX UE 115 may retransmit the groupcast message. In mode one groupcast feedback, if one of the RX UEs 115 repeatedly sends the NACK feedback message for the groupcast message, the TX UE 115 may continue to retransmit the groupcast message consuming resources. In some cases, the RX UE 115 may have an equipment fault causing the NACK feedback messages or a rouge UE may be purposefully sending the NACK feedback messages to block resources (e.g., may be a rogue UE).

To address the potential repeating NACK feedback messages and associated repeating retransmissions, the TX UE 115 may handle groupcast feedback communication by starting the groupcast communication using mode one groupcast feedback and by changing to mode two groupcast feedback based on a metric of the retransmissions exceeding a threshold. For example, the TX UE 115 may transmit control signaling indicating mode one groupcast feedback. The TX UE 115 may transmit a plurality of groupcast messages and receive one or more NACK feedback messages associated with the plurality of groupcast messages. The TX UE 115 may perform one or more retransmissions of groupcast messages based on the received NACK feedback messages. If a metric of the one or more retransmissions exceeds a threshold quantity, the TX UE 115 may transmit second control signaling indicating the mode two groupcast feedback. The metric of the one or more retransmissions may include a block error rate of the one or more retransmissions or a quantity of the one or more retransmissions.

The TX UE 115 may transmit a second plurality of groupcast messages and may receive one or more mode two feedback messages (e.g., NACK feedback messages or ACK feedback messages associated with one or more of the second plurality of groupcast messages). Using the mode two groupcast feedback messages, the TX UE may identify one of the RX UEs 115 sending repeating NACK feedback messages. After identifying the RX UE 115 sending the repeating NACK feedback messages, the TX UE 115 may transmit control signaling indicating mode one groupcast feedback. While operating in the mode one groupcast feedback, the TX UE 115 may ignore the NACK feedback messages, may suppress the retransmissions associated with the NACK feedback messages, or may remove the identified RX UE 115 from groupcast communication. Additionally, the TX UE 115 may transmit a message indicating a presence of a rogue UE or faulty UE to other UEs 115, to a network entity 105, or to a vehicle-to-everything (V2X) server.

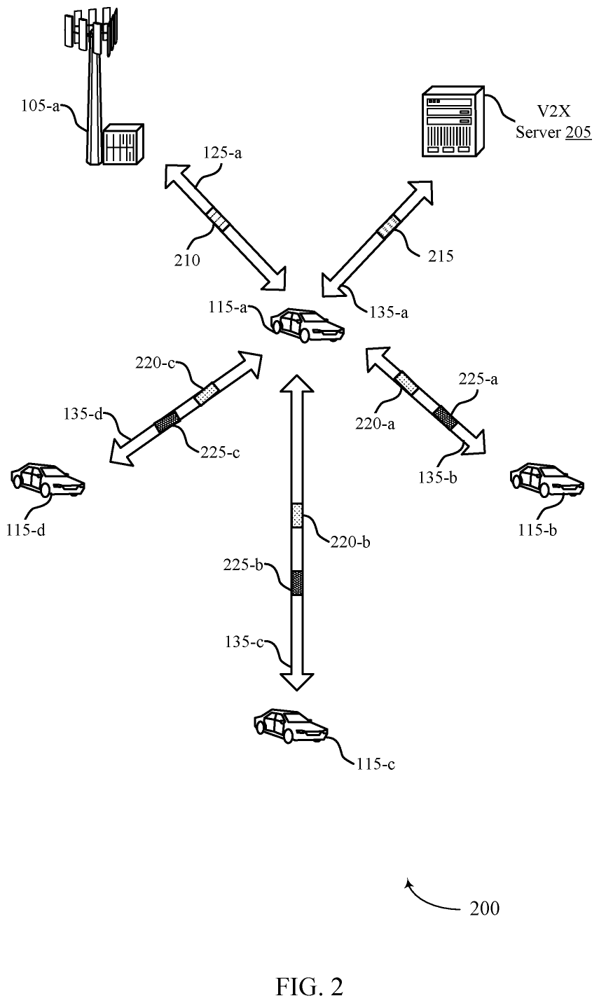

FIG. 2 shows an example of a wireless communications system 200 that supports techniques for handling groupcast feedback communication in accordance with one or more aspects of the present disclosure. The wireless communications system 200 may implement aspects of or may be implemented by aspects of the wireless communications system 100. For example, the wireless communications system 200 may include a UE 115-a, a UE 115-b and a UE 115-c which may be examples of the UE 115 as described herein. The wireless communications system 200 may also include a network entity 105-a, which may be an example of a network entity 105 as described herein. The wireless communications system 200 may also include V2X server 205.

The UE 115-a may communicate with the network entity 105-a using a communication link 125-a. The communication link 125-a may be an example of an NR or LTE link between the UE 115-a and the network entity 105-a. The communication link 125-a may include bi-directional links that enable both uplink and downlink communications. For example, the UE 115-a may transmit uplink signals (e.g., uplink transmissions), such as uplink control signals or uplink data signals, to the network entity 105-a using the communication link 125-a, and the network entity 105-a may transmit downlink signals (e.g., downlink transmissions), such as downlink control signals or downlink data signals, to the UE 115-a using the communication link 125-a. In some examples, the UE 115-a may transmit, to the network entity 105-a, signaling 210 indicating one of the UEs (e.g., UE 115-b, UE 115-c or UE 115-d) has violated a limit associated with NACK feedback messages.

The UE 115-a may communicate with the V2X server 205 using communication link 135-a, which may be examples of a communication link 135 as described herein. For example, the communication link 135-a may be a sidelink communication link and may support bidirectional communications between the V2X server 205 and the UE 115-a. In some examples, the UE 115-a may transmit, to the V2X server 205, signaling 215 indicating one of the UEs (e.g., UE 115-b, UE 115-c or UE 115-d) has violated a limit associated with NACK feedback messages. Alternatively to using communication link 135-a, communication between UE 115-a and V2X server 205 may go through network entity 105-a (e.g., V2X server may be connected to network entity 105-a through one or more links).

The UE 115-a may communicate with the UE 115-b using communication link 135-b, which may be examples of a communication link 135 as described herein. For example, the communication link 135-a may be a sidelink communication link and may support bidirectional communications between the UE 115-a and the UE 115-b. In some examples, the UE 115-a may transmit, to the UE 115-b, groupcast messages 220-a, and the UE 115-a may receive, from the UE 115-b, feedback messages 225-a. Similarly, the UE 115-a may communicate with the UE 115-c using communication link 135-c, which may be examples of a communication link 135 as described herein. For example, the communication link 135-c may be a sidelink communication link and may support bidirectional communications between the UE 115-a and the UE 115-c. In some examples, the UE 115-a may transmit, to the UE 115-c, groupcast messages 220-b, and the UE 115-a may receive, from the UE 115-c, feedback messages 225-b. Likewise, the UE 115-a may communicate with the UE 115-d using communication link 135-d, which may be examples of a communication link 135 as described herein. For example, the communication link 135-d may be a sidelink communication link and may support bidirectional communications between the UE 115-a and the UE 115-d. In some examples, the UE 115-a may transmit, to the UE 115-d, groupcast messages 220-c, and the UE 115-a may receive, from the UE 115-d, feedback messages 225-c. In some cases, the messages 220-a, the messages 220-b and the message 220-c may be the same groupcast message.

In some examples, the UE 115-a may transmit a message to one of the UEs (e.g., UE 115-b, UE 115-c or UE 115-d) in unicast (e.g., point to point communication from the TX UE to a specific RX UE). After the unicast transmission, the UE 115-a may wait for a HARQ feedback message from the RX UE. The HARQ feedback message may include an ACK feedback message if reception of the transport block was successful and a NACK feedback message if reception of the transport block was unsuccessful.

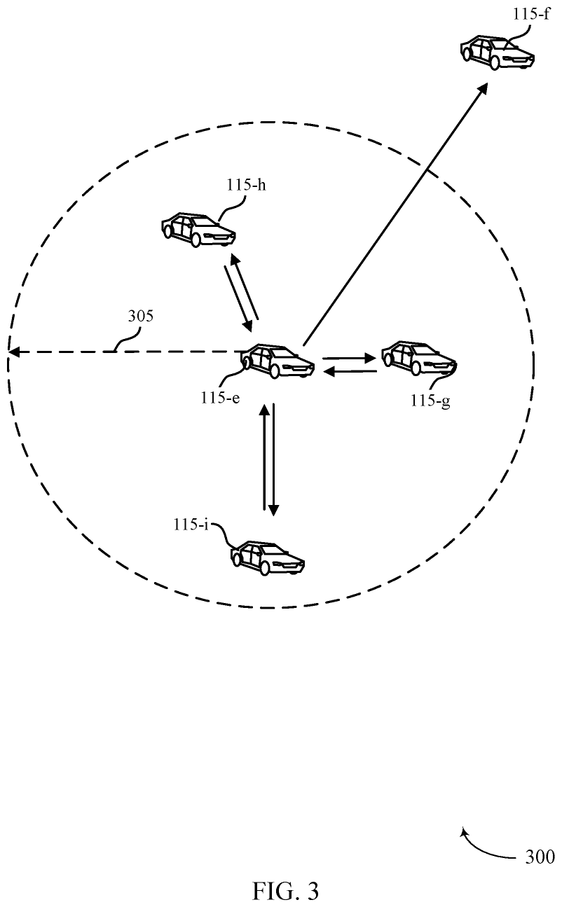

FIG. 3 shows an example of a wireless communications system 300 that supports techniques for handling groupcast feedback communication in accordance with one or more aspects of the present disclosure. The wireless communications system 300 may implement aspects of or may be implemented by aspects of the wireless communications system 100 and wireless communications system 200. For example, the wireless communications system 300 includes a TX UE 115-e, a UE 115-f, UE 115-g, and a UE 115-h which may be examples of the UEs 115 as described herein.

In some examples, the TX UE 115-e may transmit a message to the UEs (e.g., a UE 115-f, UE 115-g, and a UE 115-h) in groupcast (e.g., the TX UE transmits the same message to a group of RX UEs). In some cases, the TX UE 115-e may receive first stage sidelink control information indicating a transport block for the message. In NR V2X, two modes (e.g., or options) may be supported for sidelink (SL) HARQ feedback. In mode one, the RX UE may transmit a NACK feedback message if the RX UE has not successfully decoded the transport block after decoding the first stage sidelink control information (SCI), and the RX UE may suppress (e.g., not transmit) an ACK feedback message if the RX UE has successfully decoded the transport block after decoding the first stage SCI.

In some cases, the mode one SL HARQ feedback may be distance-based HARQ feedback. For distance-based HARQ feedback, RX UEs within a configured distance may decode the message transmitted by the TX UE 115-e. One example of distance-based HARQ feedback may be at a traffic junction with the TX UE 115-e transmitting a message regarding the location proximate the traffic junction to RX UEs within the configured distance. For distance-based HARQ feedback, the RX UE may attempt decoding of the transport block if a relative distance to the TX UE 115-e (referred to as the Tx-Rx distance) is less than or equal to the configured communication range 305 indicated in second stage SCI. If the relative distance is greater than the communication range 305, the RX UE may not decode the transport block and may not transmit the HARQ feedback message. For example, the TX UE 115-e may transmit a groupcast message to the UE 115-f, the UE 115-g, the UE 115-h, and the UE 115-i. For distance-based HARQ feedback, the UE 115-f may have a relative distance greater than the configured communication range 305, the UE 115-f may not attempt to decode the message and the UE 115-f may not transmit the NACK feedback message to the TX UE 115-e. The UE 115-g, the UE 115-h, and the UE 115-i may each have a relative distance less than the communication range 305, and the UE 115-g, the UE 115-h, and the UE 115-i may attempt to decode the message. In some cases, the UE 115-g and the UE 115-h may successfully decode the transport block and may refrain from transmitting the NACK feedback message to the TX UE 115-e. The UE 115-i may unsuccessfully decode the transport block and may transmit a NACK feedback message to the TX UE 115-e.

In mode two, the RX UE may transmit the ACK feedback message if the RX UE has successfully decoded the transport block after decoding the first stage SCI or may transmit the NACK feedback message if the RX UE has not successfully decoded the transport block after decoding the first stage SCI. Mode two may support NACK and ACK feedback messages from all of the RX UEs. For example, the TX UE 115-e, the UE 115-g, the UE 115-h, and UE 115-i may be a managed groupcast. In some cases, the TX UE 115-e may transmit a groupcast message to the UE 115-g, the UE 115-h, and UE 115-i. The UE 115-g and the UE 115-h may successfully decode the transport block and may transmit, on assigned resources, the ACK feedback message to the TX UE 115-e. The UE 115-i may unsuccessfully decode the transport block and may transmit the NACK feedback message, on assigned resources to the TX UE 115-e.

In mode one, the RX UEs (e.g., the UE 115-g, the UE 115-h, and UE 115-i) of a transmission share a resource for sending the respective NACK feedback messages, so the TX UE 115-e may not identify which RX UEs sent the NACK feedback message. If the TX UE 15-e receives at least one NACK feedback message in mode one, the TX UE 115-e may be aware that at least one RX UE (e.g., the UE 115-g, the UE 115-h, and UE 115-i) within the configured communication range 305 did not correctly decode the transport block. If the TX UE 115-e receives one NACK feedback message corresponding to the transmitted groupcast message, the TX UE 115-e may retransmit the groupcast message again to all of the RX UEs (e.g., the UE 115-g, the UE 115-h, and UE 115-i). In mode two, the TX UE 115-e may distinguish the HARQ feedback messages of the RX UEs using group IDs of the RX UEs and the assigned resource of the received HARQ feedback message, which may enable the TX UE to perform a retransmission to the specific RX UE that transmitted the NACK feedback message.

When TX UE 115-e operates in mode one, if one or more RX UEs (e.g., the UE 115-g, the UE 115-h, and UE 115-i) are sending the NACK feedback message repeatedly, then the TX UE 115-e may retransmit the groupcast message again, and the TX UE 115-e may not be aware if the NACK feedback message is repeatedly being sent by a specific RX UE. In some cases, one RX UE may be the source of the repeating NACK feedback messages. For example, one of the RX UEs may estimate its location incorrectly because of non-line-of-sight (non-LOS), interference, or positioning module damage, and in these cases, the RX UE may incorrectly estimate its distance to the TX UE 115-e to be less than the communication range 305 configured by the TX UE 115-e even though the RX UE is beyond the communication range 305. For example, due to the location of the RX UE, the RX UE may be unable to correctly decode the transport block and may transmit the NACK feedback message to the TX UE 115-e. In some cases, there may be a rogue RX UE that may purposefully transmit the NACK feedback message to the TX UE 115-e to block resources.

To address the potential continuous NACK feedback and associated repeated retransmissions, the TX UE 115-e may handle groupcast feedback communication by starting the groupcast communication using mode one groupcast feedback and dynamically changing to mode two groupcast feedback based on a metric of the retransmissions satisfying (e.g., exceeding, or meeting or exceeding) a threshold. In some examples, the TX UE 115-e may decide to use mode one feedback or mode two feedback. In some cases, the TX UE 115-e may use mode one feedback because it may consume less resources. For example, the TX UE 115-e may transmit control signaling indicating mode one groupcast feedback the RX UEs (e.g., the UE 115-g, the UE 115-h, and UE 115-i). In some examples, the TX UE 115-e may indicate the mode one feedback in second stage SCI.

When the TX UE 115-e uses mode one, if there is a NACK feedback message for the transmitted groupcast message, the TX UE 115-e may re-transmit the groupcast message with increased transmission power within the maximum transmit power level (MTPL). If there are several or continuous NACK feedback messages received associated with the groupcast message, the TX UE 115-e may be re-transmitting the same data again and again which consumes additional resources. In some examples, if a metric of the one or more retransmissions satisfies a threshold quantity, the TX UE 115-e switches to mode two feedback. The metric of the one or more retransmissions may include a block error rate of the one or more retransmissions or a quantity of the one or more retransmissions. In some examples, an additional consideration may be whether a quantity of the NACK feedback messages is consistent with the quantity of re-transmissions. For example, the quantity of feedback messages may be equal to the quantity of re-transmissions or the quantity of feedback messages is within a threshold of the quantity of re-transmissions.

After the TX UE 115-e decides to switch to mode two groupcast feedback, the TX UE 115-e may transmit control signaling indicating mode two groupcast feedback to the RX UEs. In some examples, the TX UE 115-e may indicate the mode two feedback in second stage SCI. Once groupcast feedback switches to mode two, the TX UE 115-e may estimate, using the associated group IDs and the assigned resources for the NACK feedback messages, whether the NACK feedback message are from a specific RX UE or whether the NACK feedback messages are from more than one of the RX UEs. For example, the TX UE 115-e may determine that a substantial quantity of the NACK feedback messages is from a specific RX UE or a proportion of the NACK feedback messages over a threshold is from a specific RX UE.

If the TX UE 115-e detects a pattern that one specific RX UE is sending repeating NACK feedback messages, then the TX UE 115-e may choose to switch back to mode one feedback, the TX UE 115-e may ignore the NACK feedback messages, the TX UE 115-e may remove the specific RX UE from the groupcast communication, the TX UE 115-e may blacklist the identified RX UE, or may choose to perform a combination of these techniques. The RX UE sending the repeating NACK feedback messages may be a rogue UE, a faulty UE, or a UE at the edge of the configured communication range 305.

In some examples, after the RX UE sending the repeating NACK feedback messages is identified, the TX UE 115-e may broadcast the possible presence of the rogue UE along with the details, such as rogue UE group ID, which may be helpful for other UEs. If the TX UE 115-e is not the group lead, the TX UE 115-e may inform the group lead of the possible presence of the rogue UE along with the details, such as the rogue UE group ID. In some cases, the TX UE 115-e may inform the network entity 105-a of the possible presence of the rogue UE along with the details, such as rogue UE group ID. The network entity 105-a may indicate possible presence of the rogue UE along with the details, such as rogue UE group ID, in a sidelink minimization of drive testing (MDT) report. In some cases, the TX UE 115-e may inform the V2X application server 205 through the application layer messaging of the possible presence of the rogue UE along with the details, such as rogue UE group ID. If multiple reports of the rogue UE are received by V2X application server 205 or the network entity 105-a, the V2X application server 205 or the network entity 105-a may inform respective authorities about the rogue UE.

In some cases, an intelligent rogue UE may not send NACK feedback messages when switched to mode two feedback. The TX UE 115-e may detect the intelligent rogue UE by identifying the NACK feedback messages during the mode one feedback and the absence of NACK feedback messages during mode two feedback. If the TX UE 115-e identifies the possible presence of the intelligent rogue, the TX UE 115-e may ignore the NACK feedback messages after switching back to mode one feedback. Additionally, the TX UE 115-e may report the possible presence of the intelligent rogue UE as described herein. Since there may be NACK feedback messages from other non-rogue RX UEs or genuine RX UEs, TX UE 115-e may not ignore each NACK feedback message, but the TX UE 115-e may reduce the maximum retransmissions to allow any genuine RX UE to decode the transmission multiple times which will increase the robustness. If TX UE 115-e detects the possible presence of the intelligence rogue UE, the TX UE 115-e may report all the RX UE IDs that report NACK feedback to other UEs, the network entity 105-a and the N2X application server 205 and indicate a suspicion or possibility that one of the reported UEs may be a rogue UE. In some examples, the TX UE 115-e may increase the transmission power in the subsequent retransmissions when identifying the possible intelligent rogue to ensure that the distance edge RX UE may successfully decode the transport block. After increasing the transmission power, if the NACK feedback messages continue in mode one, the TX UE 115-e may determine the possible presence of the rogue UE or faulty UE.

In some examples, the TX UE 115-e may handle groupcast feedback communication by starting the groupcast communication using mode one groupcast feedback and dynamically changing to mode two groupcast feedback based on a metric of the retransmissions satisfying a threshold. For example, the TX UE 115-e may transmit groupcast messages using mode one feedback. If the quantity of retransmissions satisfies a threshold, the TX UE 115-e may switch to mode two feedback and transmit groupcast messages. If the TX UE 115-e identifies that the same RX UE is sending the NACK feedback messages, the TX UE 115-e may identify the rogue UE or faulty UE, the TX UE 115-e may switch back to mode one feedback and perform retransmission a predetermined quantity of times that may be less than the quantity of received NACK feedback messages (e.g., per transport block). If the TX UE 115-e does not receive NACK feedback messages after switching to mode two feedback, the TX UE 115-e may switch to mode one feedback, and the TX UE 115-e may perform retransmission a predetermined quantity of times that may be less than the quantity of received NACK feedback messages. The TX UE 115-e may report the presence of any rogue UE or faulty UE and switch to mode one feedback.

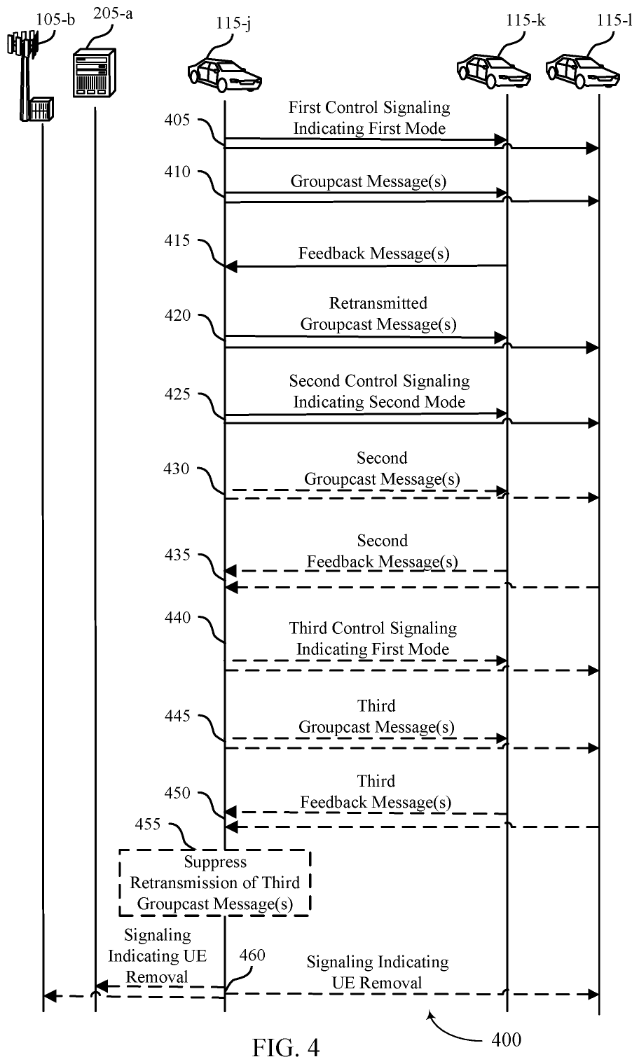

FIG. 4 shows an example of a process flow 400 that supports techniques for handling groupcast feedback communication in accordance with one or more aspects of the present disclosure. In some examples, the process flow 400 may implement or be implemented by aspects of the wireless communications systems 100, 200 and 300 as described with reference to FIGS. 1, 2, and 3, respectively. For example, the process flow 400 may be implemented by a network entity 105-b, which may be an example of the network entities 105 as described with reference to FIGS. 1 and 2, respectively. For example, the process flow 400 may be implemented by a first UE 115-j, a second UE 115-k, and a third UE 115-1, which may be an example of the UEs 115 as described with reference to FIGS. 1, 2, and 3. For example, the process flow 400 may be implemented by a V2X server 205-a, which may be an example of the V2X server 205 as described with reference to FIG. 2.

In some examples, the operations illustrated in process flow 400 may be performed by hardware (e.g., including circuitry, processing blocks, logic components, and other components), code (e.g., software executed by a processor), or any combination thereof. Alternative examples of the following may be implemented, where some steps are performed in a different order than described or are not performed at all. In some cases, steps may include additional features not mentioned below, or further steps may be added.

At 405, the first UE 115-j may transmit first control signaling indicating a first mode of groupcast feedback. The first mode of groupcast feedback may be associated with transmission of NACK feedback and suppression of ACK feedback. The second UE 115-k and the third UE 115-1 may receive the first control signaling indicating the first mode of groupcast feedback.

At 410, the first UE 115-j may transmit a plurality of groupcast messages, and each of the plurality of groupcast messages may include a respective transport block. The second UE 115-k and the third UE 115-1 may receive the plurality of groupcast messages.

At 415, the first UE 115-j may receive one or more NACK feedback messages associated with one or more of the plurality of groupcast messages according to the first mode. Each of the one or more NACK feedback messages may indicate that reception of at least a portion of the respective transport block was unsuccessful. For example, the second UE 115-k may transmit the NACK feedback message indicating that reception of at least a portion of the respective transport block was unsuccessful, and the third UE 115-1 may refrain from transmitting the NACK feedback message indicating that reception of the respective transport block was successful.

At 420, the first UE 115-j may perform one or more retransmissions of the one or more of the plurality of groupcast messages based on the one or more NACK feedback messages.

At 425, the first UE 115-j may transmit second control signaling indicating a second mode of groupcast feedback based on a metric of the one or more retransmissions exceeding a first threshold. The second mode of groupcast feedback may be associated with monitoring for NACK feedback and ACK feedback. In some examples, the metric of the one or more retransmissions may include a block error rate of the one or more retransmissions, and the first UE 115-j may transmit the second control signaling based on a block error rate exceeding the first threshold. In some cases, the metric of the one or more retransmissions may include a quantity of the one or more NACK feedback messages.

At 430, the first UE 115-j may transmit a second plurality of groupcast messages.

At 435, the first UE 115-j may receive, from the second UE 115-k, one or more second NACK feedback messages associated with one or more of the second plurality of groupcast messages according to the second mode groupcast feedback. In some examples, the first UE 115-j may estimate if the second NACK feedback messages are from a specific RX UE using the associated group IDs and the assigned resources associated with the second NACK feedback messages. For example, the first UE 115-k may determine that a substantial quantity of the second NACK feedback messages is from the second UE 115-k or a proportion of the second NACK feedback messages over a threshold is from the second UE 115-k.

At 440, the first UE 115-j may transmit third control signaling indicating the first mode of groupcast feedback. For example, the first UE 115-j may transmit the third control signaling indicating the first mode of groupcast feedback based on identifying the second NACK feedback messages are from the second UE 115-k.

At 445, the first UE 115-j may transmit a third plurality of groupcast messages.

At 450, the first UE 115-j may receive one or more third NACK feedback messages associated with one or more of the third plurality of groupcast messages according to the first mode.

At 455, the first UE 115-j may suppress one or more retransmissions of the one or more of the third plurality of groupcast messages based on the one or more third NACK feedback messages. In some examples, the UE 115-j may perform a fixed quantity of retransmissions of the one or more of the third plurality of groupcast messages based on the one or more third NACK feedback messages. For example, the first UE 115-j may suppress one or more retransmissions of the one or more of the third plurality of groupcast messages based on identifying the second NACK feedback messages are from the second UE 115-k.

At 460, the first UE 115-j may transmit, to the network entity 105-b, to the V2X server 205-a, or to the third UE 115-1 or any combination thereof, signaling indicating a removal of the second UE 115-k from groupcast communication. In some examples, the UE 115-j may transmit, to the network entity 105-b, to the V2X server 205-a, to the third UE 115-1, or any combination thereof, signaling indicating the second UE 115-k has violated a limit associated with NACK feedback messages.

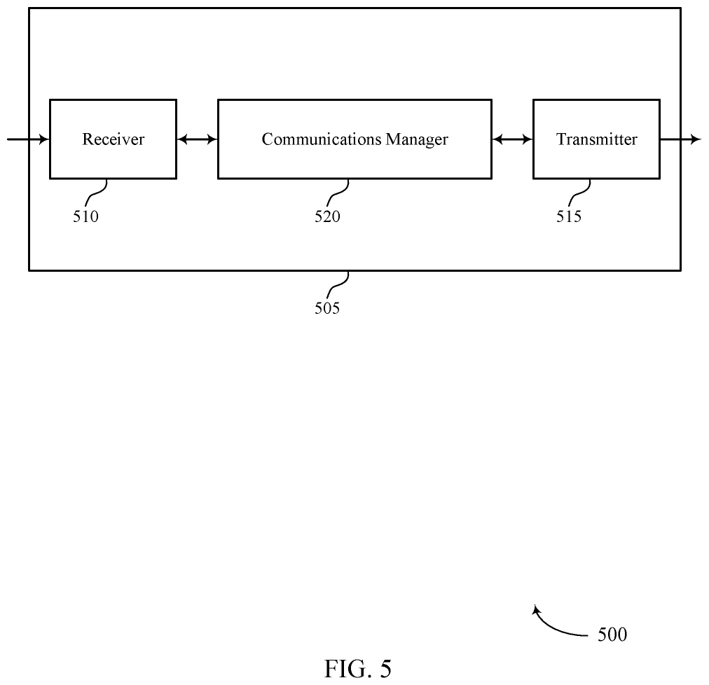

FIG. 5 shows a block diagram 500 of a device 505 that supports techniques for handling groupcast feedback communication in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for handling groupcast feedback communication). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for handling groupcast feedback communication). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of techniques for handling groupcast feedback communication as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor. If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication in accordance with examples as disclosed herein. For example, the communications manager 520 is capable of, configured to, or operable to support a means for transmitting first control signaling indicating a first mode of groupcast feedback, where the first mode is associated with transmission of NACK feedback and suppression of ACK feedback. The communications manager 520 is capable of, configured to, or operable to support a means for transmitting a set of multiple groupcast messages, each of the set of multiple groupcast messages including a respective transport block. The communications manager 520 is capable of, configured to, or operable to support a means for receiving one or more NACK feedback messages associated with one or more of the set of multiple groupcast messages according to the first mode, where each of the one or more NACK feedback messages indicates that reception of at least a portion of the respective transport block was unsuccessful. The communications manager 520 is capable of, configured to, or operable to support a means for performing one or more retransmissions of the one or more of the set of multiple groupcast messages based on the one or more NACK feedback messages. The communications manager 520 is capable of, configured to, or operable to support a means for transmitting second control signaling indicating a second mode of groupcast feedback based on a metric of the one or more retransmissions exceeding a first threshold, where the second mode is associated with monitoring for NACK feedback and ACK feedback.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for more efficient utilization of communication resources.

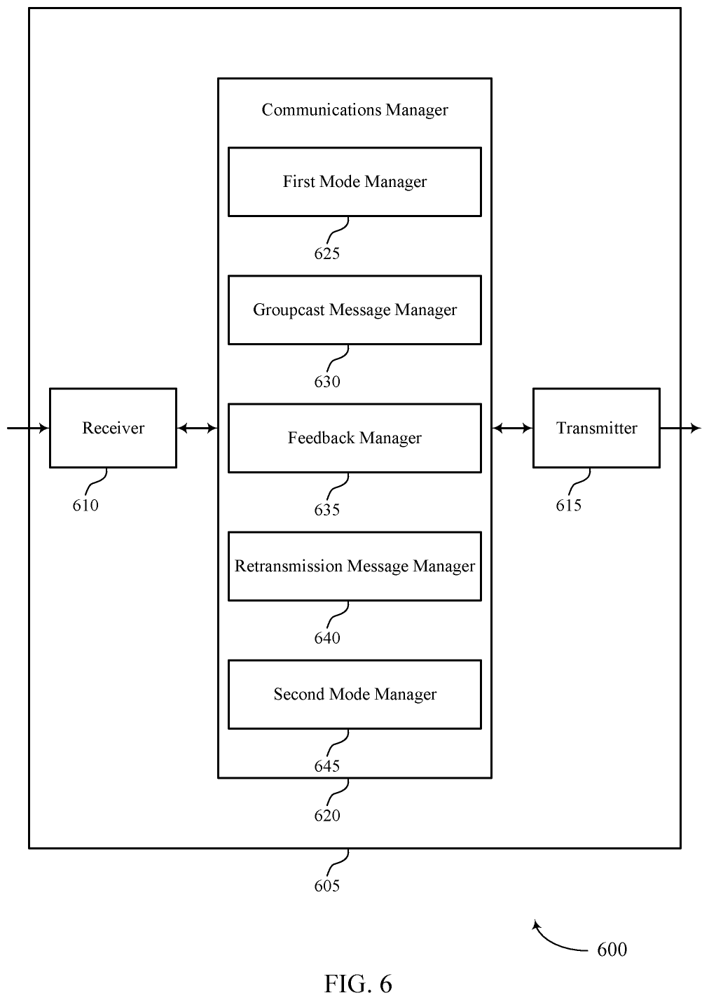

FIG. 6 shows a block diagram 600 of a device 605 that supports techniques for handling groupcast feedback communication in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for handling groupcast feedback communication). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for handling groupcast feedback communication). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of techniques for handling groupcast feedback communication as described herein. For example, the communications manager 620 may include a first mode manager 625, a groupcast message manager 630, a feedback manager 635, a retransmission message manager 640, a second mode manager 645, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication in accordance with examples as disclosed herein. The first mode manager 625 is capable of, configured to, or operable to support a means for transmitting first control signaling indicating a first mode of groupcast feedback, where the first mode is associated with transmission of NACK feedback and suppression of ACK feedback. The groupcast message manager 630 is capable of, configured to, or operable to support a means for transmitting a set of multiple groupcast messages, each of the set of multiple groupcast messages including a respective transport block. The feedback manager 635 is capable of, configured to, or operable to support a means for receiving one or more NACK feedback messages associated with one or more of the set of multiple groupcast messages according to the first mode, where each of the one or more NACK feedback messages indicates that reception of at least a portion of the respective transport block was unsuccessful. The retransmission message manager 640 is capable of, configured to, or operable to support a means for performing one or more retransmissions of the one or more of the set of multiple groupcast messages based on the one or more NACK feedback messages. The second mode manager 645 is capable of, configured to, or operable to support a means for transmitting second control signaling indicating a second mode of groupcast feedback based on a metric of the one or more retransmissions exceeding a first threshold, where the second mode is associated with monitoring for NACK feedback and ACK feedback.

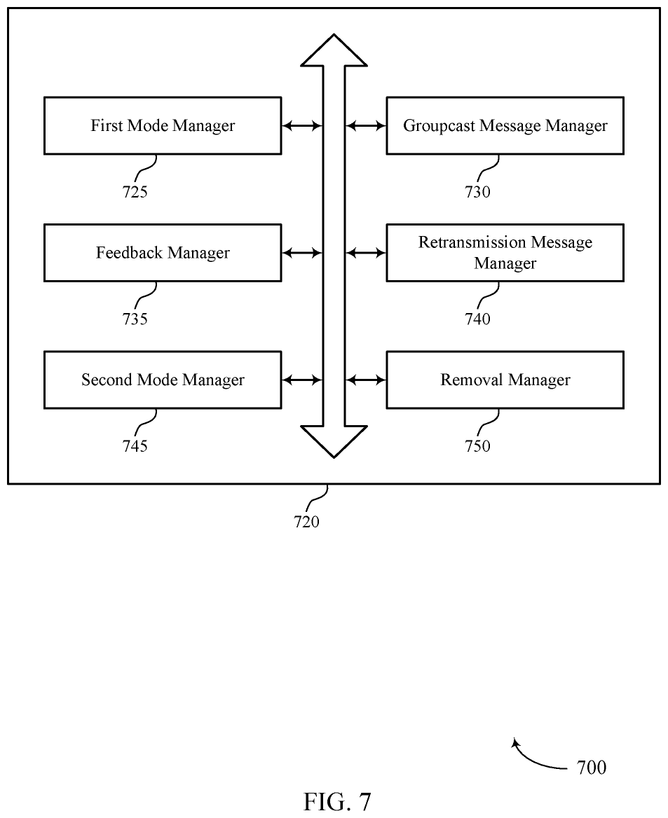

FIG. 7 shows a block diagram 700 of a communications manager 720 that supports techniques for handling groupcast feedback communication in accordance with one or more aspects of the present disclosure. The communications manager 720 may be an example of aspects of a communications manager 520, a communications manager 620, or both, as described herein. The communications manager 720, or various components thereof, may be an example of means for performing various aspects of techniques for handling groupcast feedback communication as described herein. For example, the communications manager 720 may include a first mode manager 725, a groupcast message manager 730, a feedback manager 735, a retransmission message manager 740, a second mode manager 745, a removal manager 750, or any combination thereof. Each of these components, or components or subcomponents thereof (e.g., one or more processors, one or more memories), may communicate, directly or indirectly, with one another (e.g., via one or more buses).

The communications manager 720 may support wireless communication in accordance with examples as disclosed herein. The first mode manager 725 is capable of, configured to, or operable to support a means for transmitting first control signaling indicating a first mode of groupcast feedback, where the first mode is associated with transmission of NACK feedback and suppression of ACK feedback. The groupcast message manager 730 is capable of, configured to, or operable to support a means for transmitting a set of multiple groupcast messages, each of the set of multiple groupcast messages including a respective transport block. The feedback manager 735 is capable of, configured to, or operable to support a means for receiving one or more NACK feedback messages associated with one or more of the set of multiple groupcast messages according to the first mode, where each of the one or more NACK feedback messages indicates that reception of at least a portion of the respective transport block was unsuccessful. The retransmission message manager 740 is capable of, configured to, or operable to support a means for performing one or more retransmissions of the one or more of the set of multiple groupcast messages based on the one or more NACK feedback messages. The second mode manager 745 is capable of, configured to, or operable to support a means for transmitting second control signaling indicating a second mode of groupcast feedback based on a metric of the one or more retransmissions exceeding a first threshold, where the second mode is associated with monitoring for NACK feedback and ACK feedback.

In some examples, to support transmitting the second control signaling, the second mode manager 745 is capable of, configured to, or operable to support a means for transmitting the second control signaling based on a block error rate exceeding the first threshold.

In some examples, the metric of the one or more retransmissions includes a quantity of the one or more NACK feedback messages.

In some examples, the groupcast message manager 730 is capable of, configured to, or operable to support a means for transmitting a second set of multiple groupcast messages. In some examples, the feedback manager 735 is capable of, configured to, or operable to support a means for receiving, from a second UE, one or more second NACK feedback messages associated with one or more of the second set of multiple groupcast messages according to the second mode. In some examples, the first mode manager 725 is capable of, configured to, or operable to support a means for transmitting third control signaling indicating the first mode of groupcast feedback.

In some examples, the groupcast message manager 730 is capable of, configured to, or operable to support a means for transmitting a third set of multiple groupcast messages. In some examples, the feedback manager 735 is capable of, configured to, or operable to support a means for receiving one or more third NACK feedback messages associated with one or more of the third set of multiple groupcast messages according to the first mode. In some examples, the retransmission message manager 740 is capable of, configured to, or operable to support a means for suppressing one or more retransmissions of the one or more of the third set of multiple groupcast messages based on the one or more third NACK feedback messages.

In some examples, the groupcast message manager 730 is capable of, configured to, or operable to support a means for transmitting a third set of multiple groupcast messages. In some examples, the feedback manager 735 is capable of, configured to, or operable to support a means for receiving one or more third NACK feedback messages associated with one or more of the third set of multiple groupcast messages according to the first mode. In some examples, the retransmission message manager 740 is capable of, configured to, or operable to support a means for performing a fixed quantity of retransmissions of the one or more of the third set of multiple groupcast messages based on the one or more third NACK feedback messages.

In some examples, the removal manager 750 is capable of, configured to, or operable to support a means for transmitting, to a third UE, to a network entity, to a vehicle-to-everything application server or any combination thereof, signaling indicating a removal of the second UE from groupcast communication.

In some examples, the removal manager 750 is capable of, configured to, or operable to support a means for transmitting, to a third UE, to a network entity, to a vehicle-to-everything application server or any combination thereof, signaling indicating the second UE has violated a limit associated with NACK feedback messages.

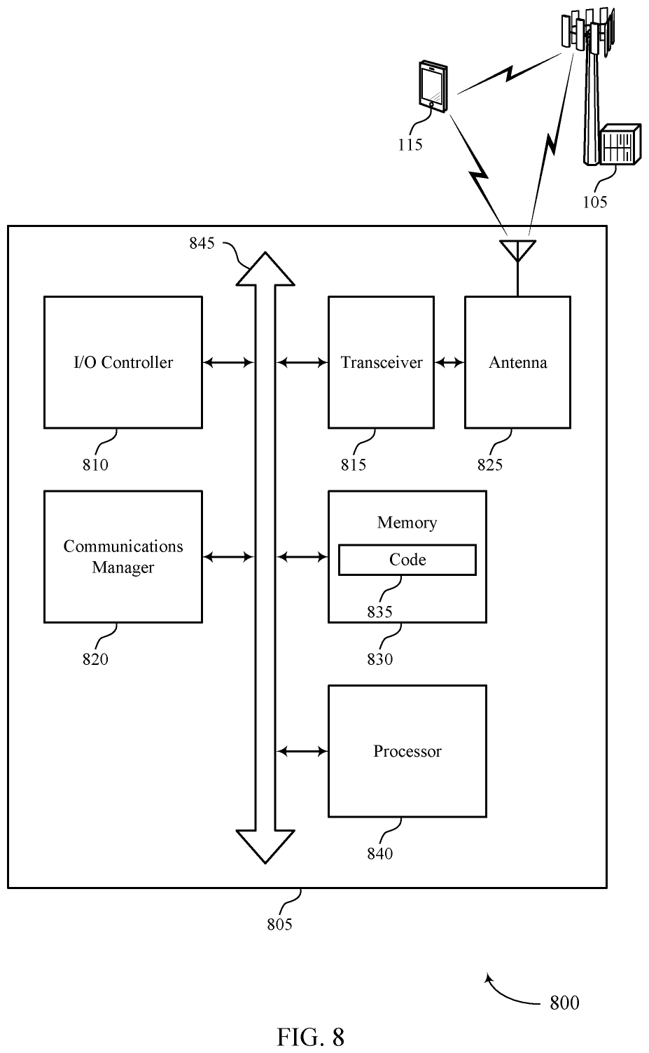

FIG. 8 shows a diagram of a system 800 including a device 805 that supports techniques for handling groupcast feedback communication in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable code 835 including instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may contain, among other things, a basic I/O system (BIOS) which may control basic hardware or software operation such as the interaction with peripheral components or devices.

The at least one processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting techniques for handling groupcast feedback communication). For example, the device 805 or a component of the device 805 may include at least one processor 840 and at least one memory 830 coupled with or to the at least one processor 840, the at least one processor 840 and at least one memory 830 configured to perform various functions described herein. In some examples, the at least one processor 840 may include multiple processors and the at least one memory 830 may include multiple memories. One or more of the multiple processors may be coupled with one or more of the multiple memories, which may, individually or collectively, be configured to perform various functions herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. As such, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code stored in the at least one memory 830 or otherwise, to perform one or more of the functions described herein.

The communications manager 820 may support wireless communication in accordance with examples as disclosed herein. For example, the communications manager 820 is capable of, configured to, or operable to support a means for transmitting first control signaling indicating a first mode of groupcast feedback, where the first mode is associated with transmission of NACK feedback and suppression of ACK feedback. The communications manager 820 is capable of, configured to, or operable to support a means for transmitting a set of multiple groupcast messages, each of the set of multiple groupcast messages including a respective transport block. The communications manager 820 is capable of, configured to, or operable to support a means for receiving one or more NACK feedback messages associated with one or more of the set of multiple groupcast messages according to the first mode, where each of the one or more NACK feedback messages indicates that reception of at least a portion of the respective transport block was unsuccessful. The communications manager 820 is capable of, configured to, or operable to support a means for performing one or more retransmissions of the one or more of the set of multiple groupcast messages based on the one or more NACK feedback messages. The communications manager 820 is capable of, configured to, or operable to support a means for transmitting second control signaling indicating a second mode of groupcast feedback based on a metric of the one or more retransmissions exceeding a first threshold, where the second mode is associated with monitoring for NACK feedback and ACK feedback.

By including or configuring the communications manager 820 in accordance with examples as described herein, the device 805 may support techniques for improved communication reliability, reduced latency, more efficient utilization of communication resources, and improved coordination between devices.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of techniques for handling groupcast feedback communication as described herein, or the at least one processor 840 and the at least one memory 830 may be otherwise configured to, individually or collectively, perform or support such operations.

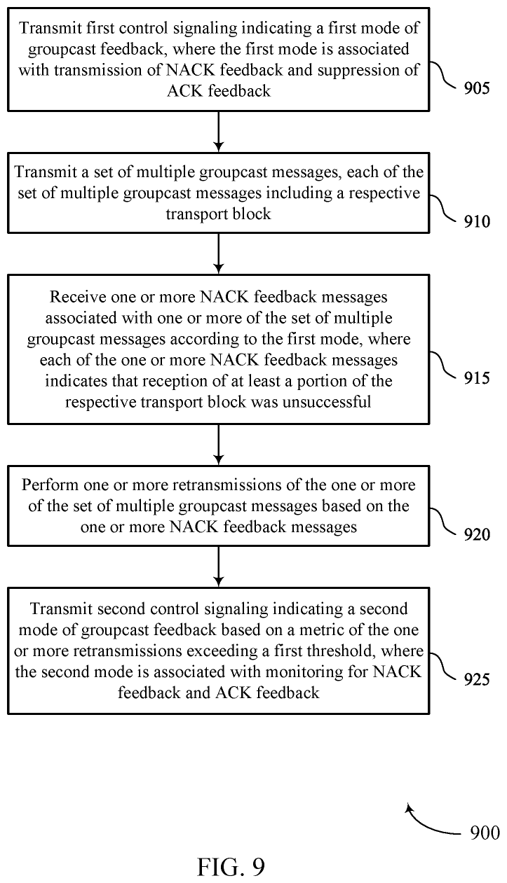

FIG. 9 shows a flowchart illustrating a method 900 that supports techniques for handling groupcast feedback communication in accordance with aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include transmitting first control signaling indicating a first mode of groupcast feedback, where the first mode is associated with transmission of NACK feedback and suppression of ACK feedback. The operations of block 905 may be performed in accordance with examples as disclosed herein. In some examples, aspects of the operations of 905 may be performed by a first mode manager 725 as described with reference to FIG. 7.

At 910, the method may include transmitting a set of multiple groupcast messages, each of the set of multiple groupcast messages including a respective transport block. The operations of block 910 may be performed in accordance with examples as disclosed herein. In some examples, aspects of the operations of 910 may be performed by a groupcast message manager 730 as described with reference to FIG. 7.

At 915, the method may include receiving one or more NACK feedback messages associated with one or more of the set of multiple groupcast messages according to the first mode, where each of the one or more NACK feedback messages indicates that reception of at least a portion of the respective transport block was unsuccessful. The operations of block 915 may be performed in accordance with examples as disclosed herein. In some examples, aspects of the operations of 915 may be performed by a feedback manager 735 as described with reference to FIG. 7.

At 920, the method may include performing one or more retransmissions of the one or more of the set of multiple groupcast messages based on the one or more NACK feedback messages. The operations of block 920 may be performed in accordance with examples as disclosed herein. In some examples, aspects of the operations of 920 may be performed by a retransmission message manager 740 as described with reference to FIG. 7.

At 925, the method may include transmitting second control signaling indicating a second mode of groupcast feedback based on a metric of the one or more retransmissions exceeding a first threshold, where the second mode is associated with monitoring for NACK feedback and ACK feedback. The operations of block 925 may be performed in accordance with examples as disclosed herein. In some examples, aspects of the operations of 925 may be performed by a second mode manager 745 as described with reference to FIG. 7.

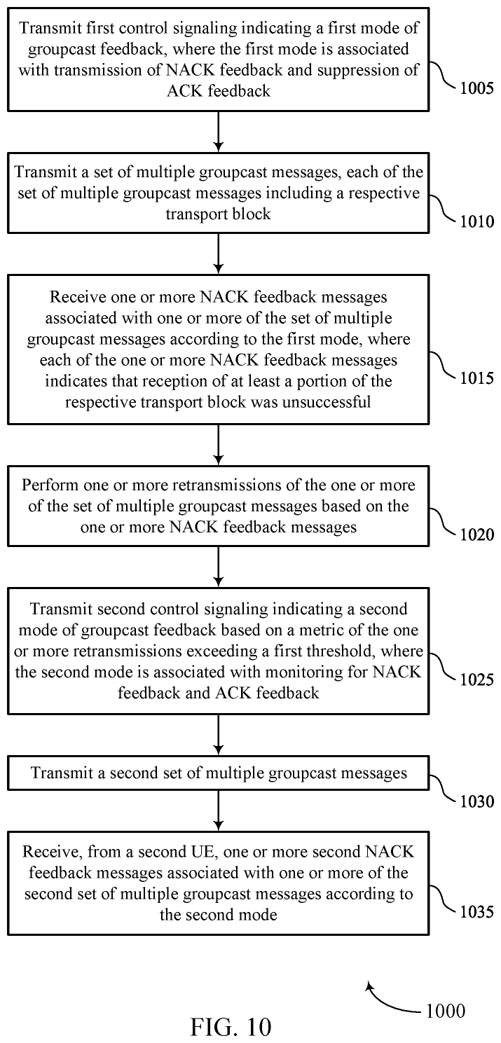

FIG. 10 shows a flowchart illustrating a method 1000 that supports techniques for handling groupcast feedback communication in accordance with aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1005, the method may include transmitting first control signaling indicating a first mode of groupcast feedback, where the first mode is associated with transmission of NACK feedback and suppression of ACK feedback. The operations of block 1005 may be performed in accordance with examples as disclosed herein. In some examples, aspects of the operations of 1005 may be performed by a first mode manager 725 as described with reference to FIG. 7.

At 1010, the method may include transmitting a set of multiple groupcast messages, each of the set of multiple groupcast messages including a respective transport block. The operations of block 1010 may be performed in accordance with examples as disclosed herein. In some examples, aspects of the operations of 1010 may be performed by a groupcast message manager 730 as described with reference to FIG. 7.

At 1015, the method may include receiving one or more NACK feedback messages associated with one or more of the set of multiple groupcast messages according to the first mode, where each of the one or more NACK feedback messages indicates that reception of at least a portion of the respective transport block was unsuccessful. The operations of block 1015 may be performed in accordance with examples as disclosed herein. In some examples, aspects of the operations of 1015 may be performed by a feedback manager 735 as described with reference to FIG. 7.

At 1020, the method may include performing one or more retransmissions of the one or more of the set of multiple groupcast messages based on the one or more NACK feedback messages. The operations of block 1020 may be performed in accordance with examples as disclosed herein. In some examples, aspects of the operations of 1020 may be performed by a retransmission message manager 740 as described with reference to FIG. 7.

At 1025, the method may include transmitting second control signaling indicating a second mode of groupcast feedback based on a metric of the one or more retransmissions exceeding a first threshold, where the second mode is associated with monitoring for NACK feedback and ACK feedback. The operations of block 1025 may be performed in accordance with examples as disclosed herein. In some examples, aspects of the operations of 1025 may be performed by a second mode manager 745 as described with reference to FIG. 7.

At 1030, the method may include transmitting a second set of multiple groupcast messages. The operations of block 1030 may be performed in accordance with examples as disclosed herein. In some examples, aspects of the operations of 1030 may be performed by a groupcast message manager 730 as described with reference to FIG. 7.

At 1035, the method may include receiving, from a second UE, one or more second NACK feedback messages associated with one or more of the second set of multiple groupcast messages according to the second mode. The operations of block 1035 may be performed in accordance with examples as disclosed herein. In some examples, aspects of the operations of 1035 may be performed by a feedback manager 735 as described with reference to FIG. 7.

The following provides an overview of aspects of the present disclosure:

Aspect 1: A method for wireless communication by a first UE, comprising: transmitting first control signaling indicating a first mode of groupcast feedback, wherein the first mode is associated with transmission of NACK feedback and suppression of ACK feedback; transmitting a plurality of groupcast messages, each of the plurality of groupcast messages comprising a respective transport block; receiving one or more NACK feedback messages associated with one or more of the plurality of groupcast messages according to the first mode, wherein each of the one or more NACK feedback messages indicates that reception of at least a portion of the respective transport block was unsuccessful; performing one or more retransmissions of the one or more of the plurality of groupcast messages based on the one or more NACK feedback messages; and transmitting second control signaling indicating a second mode of groupcast feedback based on a metric of the one or more retransmissions exceeding a first threshold, wherein the second mode is associated with monitoring for NACK feedback and ACK feedback.

Aspect 2: The method of aspect 1, wherein the metric of the one or more retransmissions comprises a block error rate of the one or more retransmissions, and wherein transmitting the second control signaling further comprises: transmitting the second control signaling based at least in part on the block error rate exceeding the first threshold.

Aspect 3: The method of aspect 1, wherein the metric of the one or more retransmissions comprises a quantity of the one or more NACK feedback messages.

Aspect 4: The method of any of aspects 1 through 3, further comprising: transmitting a second plurality of groupcast messages; receiving, from a second UE, one or more second NACK feedback messages associated with one or more of the second plurality of groupcast messages according to the second mode; and transmitting third control signaling indicating the first mode of groupcast feedback.

Aspect 5: The method of aspect 4, further comprising: transmitting a third plurality of groupcast messages; receiving one or more third NACK feedback messages associated with one or more of the third plurality of groupcast messages according to the first mode; and suppressing one or more retransmissions of the one or more of the third plurality of groupcast messages based on the one or more third NACK feedback messages.

Aspect 6: The method of aspect 4, further comprising: transmitting a third plurality of groupcast messages; receiving one or more third NACK feedback messages associated with one or more of the third plurality of groupcast messages according to the first mode; and performing a fixed quantity of retransmissions of the one or more of the third plurality of groupcast messages based on the one or more third NACK feedback messages.

Aspect 7: The method of any of aspects 4 through 6, further comprising: transmitting, to a third UE, to a network entity, to a vehicle-to-everything application server or any combination thereof, signaling indicating a removal of the second UE from groupcast communication.

Aspect 8: The method of any of aspects 4 through 7, further comprising: transmitting, to a third UE, to a network entity, to a vehicle-to-everything application server or any combination thereof, signaling indicating the second UE has violated a limit associated with NACK feedback messages.

Aspect 9: A first UE for wireless communication, comprising one or more memories storing processor-executable code, and one or more processors coupled with the one or more memories and individually or collectively operable to execute the code to cause the first UE to perform a method of any of aspects 1 through 8.

Aspect 10: A first UE for wireless communication, comprising at least one means for performing a method of any of aspects 1 through 8.

Aspect 11: A non-transitory computer-readable medium storing code for wireless communication, the code comprising instructions executable by a processor to perform a method of any of aspects 1 through 8.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first user equipment (UE), comprising:
one or more memories storing processor-executable code; and
one or more processors coupled with the one or more memories and individually or collectively operable to execute the code to cause the first UE to:
transmit first control signaling indicating a first mode of groupcast feedback, wherein the first mode is associated with transmission of negative acknowledgment (NACK) feedback and suppression of acknowledgment (ACK) feedback;
transmit a plurality of groupcast messages, each of the plurality of groupcast messages comprising a respective transport block;
receive one or more NACK feedback messages associated with one or more of the plurality of groupcast messages according to the first mode, wherein each of the one or more NACK feedback messages indicates that reception of at least a portion of the respective transport block was unsuccessful;
perform one or more retransmissions of the one or more of the plurality of groupcast messages based on the one or more NACK feedback messages; and
transmit second control signaling indicating a second mode of groupcast feedback based on a metric of the one or more retransmissions exceeding a first threshold, wherein the second mode is associated with monitoring for NACK feedback and ACK feedback.

2. The first UE of claim 1, wherein, to transmit the second control signaling, the one or more processors are individually or collectively further operable to execute the code to cause the first UE to:
transmit the second control signaling based at least in part on a block error rate exceeding the first threshold.

3. The first UE of claim 1, wherein the metric of the one or more retransmissions comprises a quantity of the one or more NACK feedback messages.

4. The first UE of claim 1, wherein the one or more processors are individually or collectively further operable to execute the code to cause the first UE to:
transmit a second plurality of groupcast messages;
receive, from a second UE, one or more second NACK feedback messages associated with one or more of the second plurality of groupcast messages according to the second mode; and
transmit third control signaling indicating the first mode of groupcast feedback.

5. The first UE of claim 4, wherein the one or more processors are individually or collectively further operable to execute the code to cause the first UE to:
transmit a third plurality of groupcast messages;
receive one or more third NACK feedback messages associated with one or more of the third plurality of groupcast messages according to the first mode; and
suppress one or more retransmissions of the one or more of the third plurality of groupcast messages based on the one or more third NACK feedback messages.

6. The first UE of claim 4, wherein the one or more processors are individually or collectively further operable to execute the code to cause the first UE to:
transmit a third plurality of groupcast messages;
receive one or more third NACK feedback messages associated with one or more of the third plurality of groupcast messages according to the first mode; and
perform a fixed quantity of retransmissions of the one or more of the third plurality of groupcast messages based on the one or more third NACK feedback messages.

7. The first UE of claim 4, wherein the one or more processors are individually or collectively further operable to execute the code to cause the first UE to:
transmit, to a third UE, to a network entity, to a vehicle-to-everything application server or any combination thereof, signaling indicating a removal of the second UE from groupcast communication.

8. The first UE of claim 4, wherein the one or more processors are individually or collectively further operable to execute the code to cause the first UE to:
transmit, to a third UE, to a network entity, to a vehicle-to-everything application server or any combination thereof, signaling indicating the second UE has violated a limit associated with NACK feedback messages.

9. A method for wireless communication by a first user equipment (UE), comprising:
transmitting first control signaling indicating a first mode of groupcast feedback, wherein the first mode is associated with transmission of negative acknowledgment (NACK) feedback and suppression of acknowledgment (ACK) feedback;
transmitting a plurality of groupcast messages, each of the plurality of groupcast messages comprising a respective transport block;
receiving one or more NACK feedback messages associated with one or more of the plurality of groupcast messages according to the first mode, wherein each of the one or more NACK feedback messages indicates that reception of at least a portion of the respective transport block was unsuccessful;
performing one or more retransmissions of the one or more of the plurality of groupcast messages based on the one or more NACK feedback messages; and
transmitting second control signaling indicating a second mode of groupcast feedback based on a metric of the one or more retransmissions exceeding a first threshold, wherein the second mode is associated with monitoring for NACK feedback and ACK feedback.

10. The method of claim 9, wherein the metric of the one or more retransmissions comprises a block error rate of the one or more retransmissions, and wherein transmitting the second control signaling further comprises:
transmitting the second control signaling based at least in part on a block error rate exceeding the first threshold.

11. The method of claim 9, wherein the metric of the one or more retransmissions comprises a quantity of the one or more NACK feedback messages.

12. The method of claim 9, further comprising:
transmitting a second plurality of groupcast messages;
receiving, from a second UE, one or more second NACK feedback messages associated with one or more of the second plurality of groupcast messages according to the second mode; and
transmitting third control signaling indicating the first mode of groupcast feedback.

13. The method of claim 12, further comprising:
transmitting a third plurality of groupcast messages;
receiving one or more third NACK feedback messages associated with one or more of the third plurality of groupcast messages according to the first mode; and
suppressing one or more retransmissions of the one or more of the third plurality of groupcast messages based on the one or more third NACK feedback messages.

14. The method of claim 12, further comprising:
transmitting a third plurality of groupcast messages;
receiving one or more third NACK feedback messages associated with one or more of the third plurality of groupcast messages according to the first mode; and
performing a fixed quantity of retransmissions of the one or more of the third plurality of groupcast messages based on the one or more third NACK feedback messages.

15. The method of claim 12, further comprising:
transmitting, to a third UE, to a network entity, to a vehicle-to-everything application server or any combination thereof, signaling indicating a removal of the second UE from groupcast communication.

16. The method of claim 12, further comprising:
transmitting, to a third UE, to a network entity, to a vehicle-to-everything application server or any combination thereof, signaling indicating the second UE has violated a limit associated with NACK feedback messages.

17. A first user equipment (UE) for wireless communication, comprising:
means for transmitting first control signaling indicating a first mode of groupcast feedback, wherein the first mode is associated with transmission of negative acknowledgment (NACK) feedback and suppression of acknowledgment (ACK) feedback;
means for transmitting a plurality of groupcast messages, each of the plurality of groupcast messages comprising a respective transport block;
means for receiving one or more NACK feedback messages associated with one or more of the plurality of groupcast messages according to the first mode, wherein each of the one or more NACK feedback messages indicates that reception of at least a portion of the respective transport block was unsuccessful;
means for performing one or more retransmissions of the one or more of the plurality of groupcast messages based on the one or more NACK feedback messages; and
means for transmitting second control signaling indicating a second mode of groupcast feedback based on a metric of the one or more retransmissions exceeding a first threshold, wherein the second mode is associated with monitoring for NACK feedback and ACK feedback.

18. The first UE of claim 17, wherein the means for transmitting the second control signaling further comprise:
means for transmitting the second control signaling based at least in part on a block error rate exceeding the first threshold.

19. The first UE of claim 17, wherein the metric of the one or more retransmissions comprises a quantity of the one or more NACK feedback messages.

20. The first UE of claim 17, further comprising:
means for transmitting a second plurality of groupcast messages;
means for receiving, from a second UE, one or more second NACK feedback messages associated with one or more of the second plurality of groupcast messages according to the second mode; and
means for transmitting third control signaling indicating the first mode of groupcast feedback.

21. The first UE of claim 20, further comprising:
means for transmitting a third plurality of groupcast messages;
means for receiving one or more third NACK feedback messages associated with one or more of the third plurality of groupcast messages according to the first mode; and
means for suppressing one or more retransmissions of the one or more of the third plurality of groupcast messages based on the one or more third NACK feedback messages.

22. The first UE of claim 20, further comprising:
means for transmitting a third plurality of groupcast messages;
means for receiving one or more third NACK feedback messages associated with one or more of the third plurality of groupcast messages according to the first mode; and
means for performing a fixed quantity of retransmissions of the one or more of the third plurality of groupcast messages based on the one or more third NACK feedback messages.

23. The first UE of claim 20, further comprising:
means for transmitting, to a third UE, to a network entity, to a vehicle-to-everything application server or any combination thereof, signaling indicating a removal of the second UE from groupcast communication.

24. A non-transitory computer-readable medium storing code for wireless communication, the code comprising instructions executable by one or more processors to:
transmit first control signaling indicating a first mode of groupcast feedback, wherein the first mode is associated with transmission of negative acknowledgment (NACK) feedback and suppression of acknowledgment (ACK) feedback;
transmit a plurality of groupcast messages, each of the plurality of groupcast messages comprising a respective transport block;
receive one or more NACK feedback messages associated with one or more of the plurality of groupcast messages according to the first mode, wherein each of the one or more NACK feedback messages indicates that reception of at least a portion of the respective transport block was unsuccessful;
perform one or more retransmissions of the one or more of the plurality of groupcast messages based on the one or more NACK feedback messages; and
transmit second control signaling indicating a second mode of groupcast feedback based on a metric of the one or more retransmissions exceeding a first threshold, wherein the second mode is associated with monitoring for NACK feedback and ACK feedback.

25. The non-transitory computer-readable medium of claim 24, wherein the instructions to transmit the second control signaling are further executable by the one or more processors to:
transmit the second control signaling based at least in part on a block error rate exceeding the first threshold.

26. The non-transitory computer-readable medium of claim 24, wherein the metric of the one or more retransmissions comprises a quantity of the one or more NACK feedback messages.

27. The non-transitory computer-readable medium of claim 24, wherein the instructions are further executable by the one or more processors to:
transmit a second plurality of groupcast messages;
receive, from a second UE, one or more second NACK feedback messages associated with one or more of the second plurality of groupcast messages according to the second mode; and
transmit third control signaling indicating the first mode of groupcast feedback.

28. The non-transitory computer-readable medium of claim 27, wherein the instructions are further executable by the one or more processors to:
transmit a third plurality of groupcast messages;
receive one or more third NACK feedback messages associated with one or more of the third plurality of groupcast messages according to the first mode; and
suppress one or more retransmissions of the one or more of the third plurality of groupcast messages based on the one or more third NACK feedback messages.

29. The non-transitory computer-readable medium of claim 27, wherein the instructions are further executable by the one or more processors to:
transmit a third plurality of groupcast messages;
receive one or more third NACK feedback messages associated with one or more of the third plurality of groupcast messages according to the first mode; and
perform a fixed quantity of retransmissions of the one or more of the third plurality of groupcast messages based on the one or more third NACK feedback messages.

30. The non-transitory computer-readable medium of claim 27, wherein the instructions are further executable by the one or more processors to:
transmit, to a third UE, to a network entity, to a vehicle-to-everything application server or any combination thereof, signaling indicating the second UE has violated a limit associated with NACK feedback messages.
